(19) United States
(12) Patent Application Publication
(10) Pub. No.: US 2009/0151111 A1
(43) Pub. Date: Jun. 18, 2009

(54) WINDSHIELD WIPER STEEL BAR STRUCTURE

(76) Inventor: Chi-Hung Chang, Taipei City (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 11/959,402

(22) Filed: Dec. 18, 2007

(51) Int. Cl. B60S 1/34

(52) U.S. Cl. 15/250.351

(57) ABSTRACT

The present invention discloses an improved windshield wiper steel bar structure having a curvely bent portion disposed separately on both ends of the steel bar, at least one dent or at least one dent or at least one penetrating hole disposed at the middle of steel bar. After the steel bar is connected with a required wiper blade, the steel bar can be used for attaching the wiper blade closely with the automobile windshield glass to achieve a more effective scraping effect.

### FIELD OF THE INVENTION

The present invention relates to an improved windshield wiper steel bar structure, and more particularly a windshield wiper connected with a steel bar for attaching the windshield wiper closely onto a windshield glass to achieve a more effective scraping effect.

### BACKGROUND OF THE INVENTION

In general, a traditional windshield wiper 5 (as shown in FIG. 1) includes two adjacent press bars 50, a penetrating groove 501 formed between the two press bars 50, a fastener 51 disposed at the middle of the press bar 50, a scraping blade 52 embedded into the penetrating groove 501 and fixed separately to clamps 53 on the two press bars 50, an accessory plate 54 disposed on both sides of the fastener 51 on the press bar 50, and two fixing element 55 capable of integrally fixing the press bar 50, the scraping blade 52 and the accessory plate 54, so as to fasten a windshield wiper holder 61 of an automobile 6 and use the windshield wiper holder 61 to drive the windshield wiper 5 to move on a windshield glass 62 of the automobile 6 and scrap rains (as shown in FIG. 2).

Since the press bar 50 includes two steel bars in the shape of a slab, there is a slight curvature at the middle of the press bar 50, but both ends of the scraping blade 52 cannot be attached closely onto a windshield glass 62 of an automobile 6 when the windshield wiper holder 61 is connected, so that a gap a is formed between both ends of the scraping blade 52 and the windshield glass 62 (as indicated by an end shown in FIG. 3). Since the windshield wiper 5 keeps moving on the windshield glass 62 during its use, stains occur on the windshield glass 62 and proximate to both ends of the scraping blade 52 during an application of scraping rains, if both ends of the scraping blade 52 cannot be attached closely with the windshield glass 62. Furthermore, an uneven force is applied due to the two adjacent press bars 50 of the scraping blade 52 and the gap a, so that the penetrating groove 501 is expanded by the force exerted onto each press bar 50, and the press bar 50 and the scraping blade 52 are loosened frequently. After a period of time, the structure of the windshield wiper 5 will be insecure and can no longer be used anymore. To solve this problem, related manufacturers usually add a curvature to the two press bars 50, so that both ends of the scraping blade 52 can be attached closely with the windshield glass 62 due to the shape of the press bars 50, but a gap is formed between the middle of the scraping blade 52 and the windshield glass 62, and the windshield wiper holder 61 requires a stronger pressing force to press the middle of the press bar 50 to prevent the formation of a gap. In addition to the left and right movements, the windshield wiper holder 61 may be bent backward from windshield glass 62, so that the structure and function of the windshield wiper holder 61 are limited, and its downward pressing force will be insufficient to prevent the formation of a gap between the middle of the scraping blade 52 and the windshield glass 62. As both ends of the scraping blade 52 are taken care, the middle of the scraping blade 52 cannot scrap the rain from the windshield glass 62. Obviously, the aforementioned prior art cannot meet the user requirements.

### SUMMARY OF THE INVENTION

Therefore, it is a primary objective of the present invention to provide an improved structure of a windshield wiper steel bar, wherein a wiper blade can be attached closely with an automobile windshield glass by a steel bar, after the wiper blade is installed to the steel bar, for achieving a more effective scraping effect.

To achieve the foregoing objectives, the present invention provides a first preferred embodiment of an improved structure of a windshield wiper steel bar in accordance with the present invention, the steel bar has a curvely bent portion disposed separately on both ends of the steel bar, and at least one dent disposed at the middle of the steel bar.

The invention also provides a second preferred embodiment of an improved structure of a windshield wiper steel bar in accordance with the present invention, wherein the steel bar has a curvely bent portion disposed separately on both ends of the steel bar, and at least one penetrating hole disposed at the middle of the steel bar.

### BRIEF DESCRIPTION OF THE DRAWINGS

FIG. 1 is an exploded view of a prior art;

FIG. 2 is a schematic view of an installation of a prior art;

FIG. 3 is a schematic view of attaching a scraping blade with a windshield glass in accordance with a prior art;

FIG. 4 is a perspective view of the present invention;

FIG. 5 is another perspective view of the present invention;

FIG. 6 is a schematic view of a windshield wiper steel bar assembled with a wiper blade in accordance with the present invention;

FIG. 7 is a schematic view of a windshield wiper steel bar connected with a wiper blade in accordance with the present invention;

FIG. 8 is a section view of a windshield wiper steel bar connected with a wiper blade in accordance with the present invention; and

FIG. 9 is a schematic view of attaching a windshield wiper steel bar with a windshield glass in accordance with the present invention.

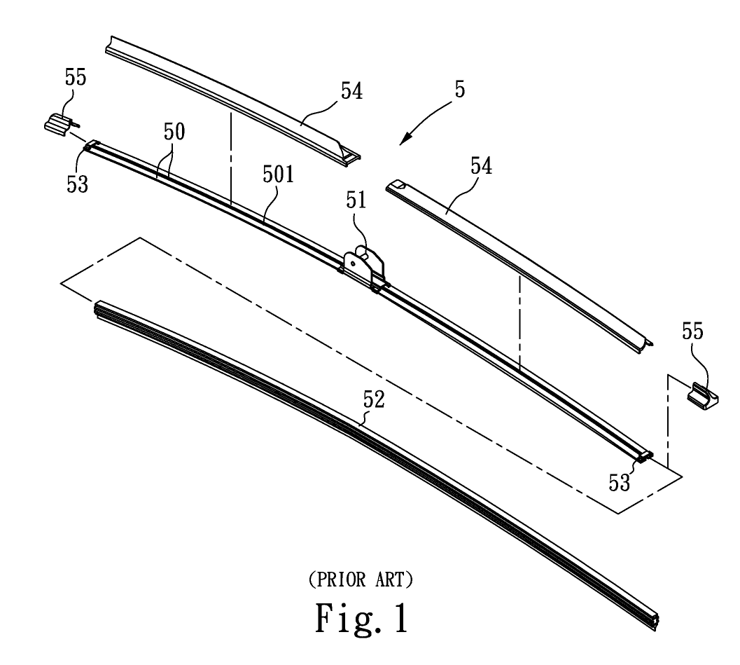

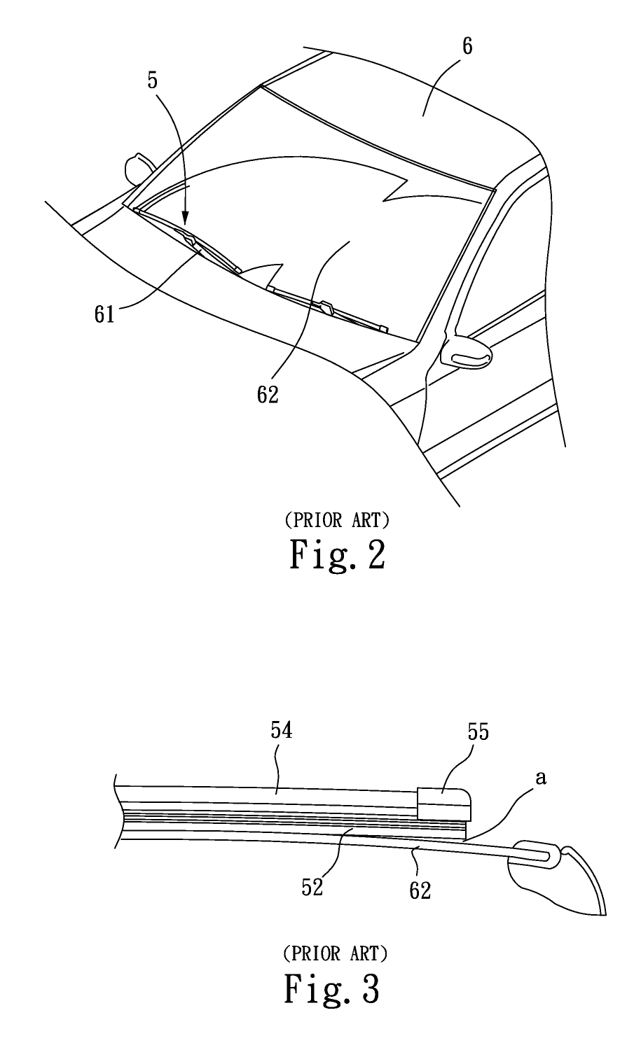

### DESCRIPTION OF THE PREFERRED EMBODIMENT

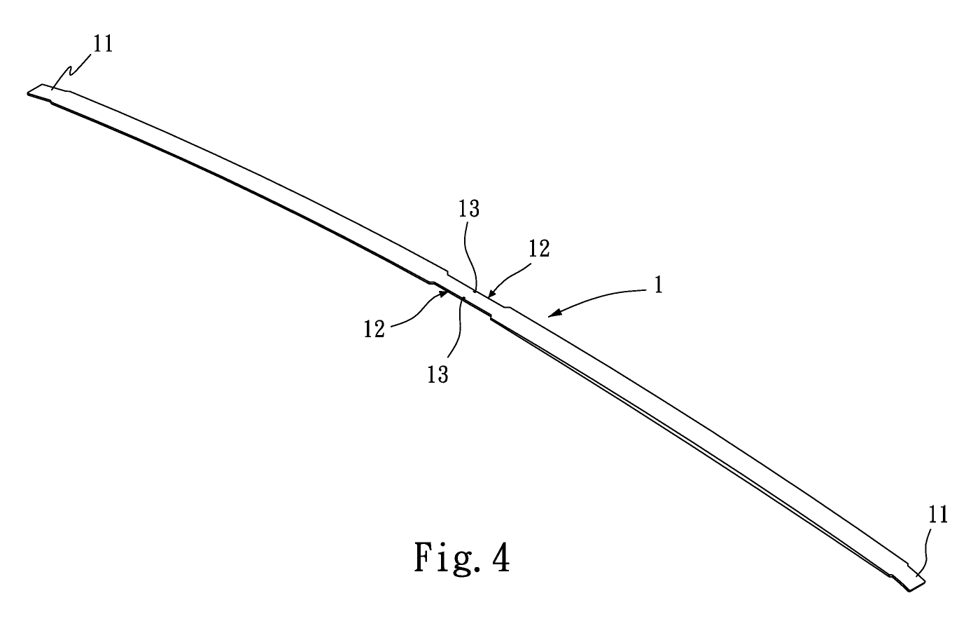

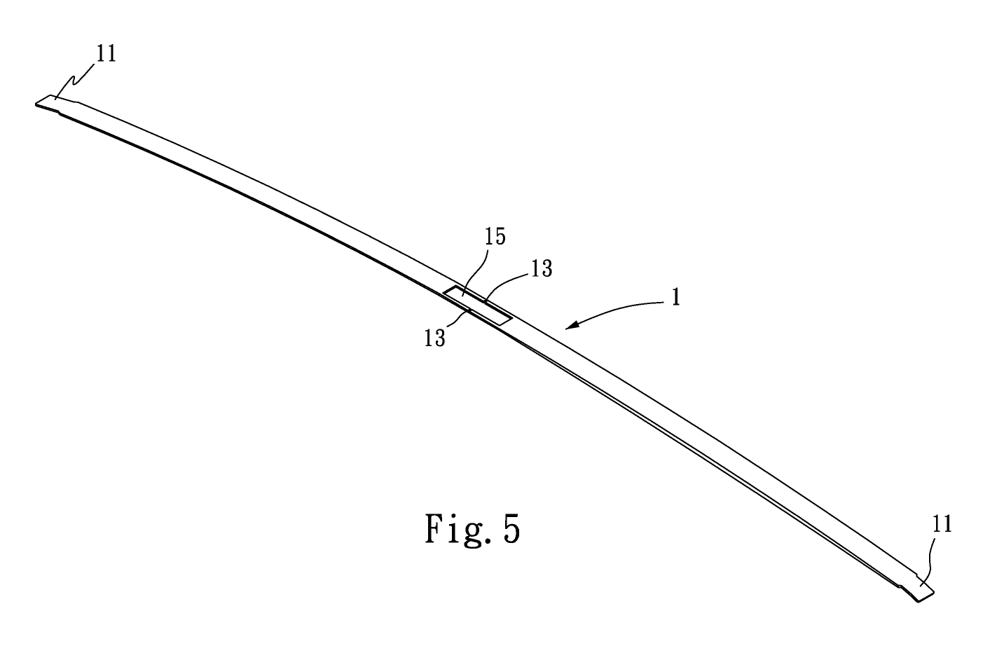

Referring to FIGS. 4 and 5 for an exploded view and a perspective view of the present invention respectively, the present invention provides an improved structure of a windshield wiper steel bar, and the steel bar 1 has a curvely bent portion 11 on both ends, and the steel bar 1 has a dent 12 on both sides of the middle of the steel bar 1 or the steel bar 1 has penetrating hole 15 at the middle to reduce the cross-sectional area of the middle of the steel bar 1, and the two dents 12 separately include a slot 13 or the penetrating hole 15 includes a slot 13 separately on both sides of the lot 13, so as to constitute an improved structure of a novel windshield wiper steel bar.

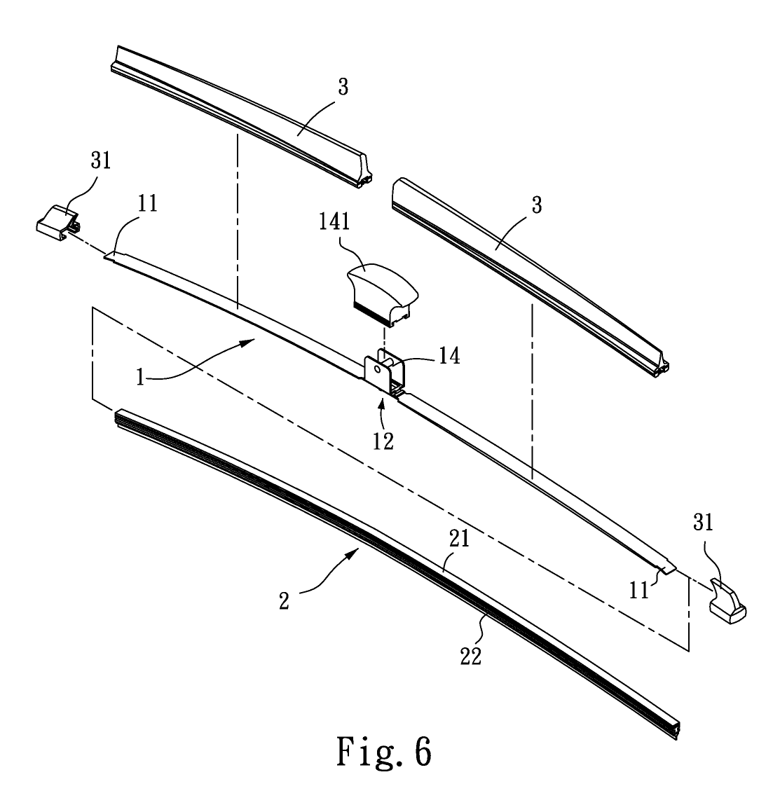

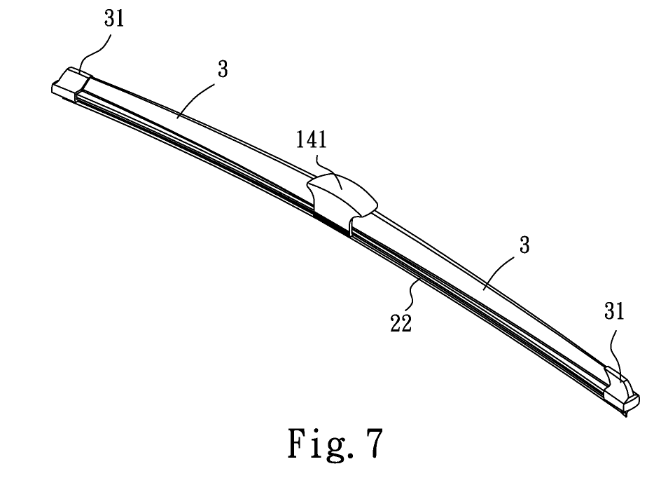

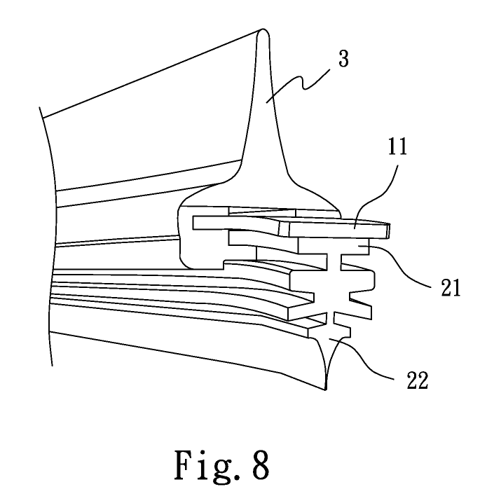

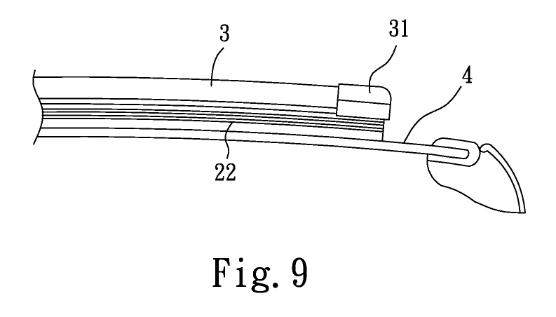

Referring to FIGS. 6 to 9 for a schematic view of assembling a windshield wiper steel bar with a wiper blade, a schematic view of connecting a windshield wiper steel bar with a wiper blade, a schematic view of a windshield wiper steel bar connected to a wiper blade, and a section view of a windshield wiper steel bar with a wiper blade connected to a wiper blade in accordance with the present invention respectively, the steel bar 1 as shown in FIG. 4 is installed by embedding the slot 13 of the steel bar 1 with a fixing base 14, and the fixing base 14 has a connecting element 141 disposed thereon, and then a joint plate 21 of the wiper blade 2 is attached onto a side of the steel bar 1, and two sheath units 3 are engaged with each other through both ends of the steel bar 1 and the wiper blade 2, and then two end cover 31 are sheathed onto both ends of the curvely bent portion 11 of the steel bar 1 and the joint plate 21 for integrally fixing the steel bar 1, the wiper blade 2 and sheath unit 3, such that the sheath unit 3 and the end covers 31 securely clamp the wiper blade 2, and the curvely bent portions 11 on both ends of the steel bar 1 clamp and press both ends of the wiper blade 2 towards the windshield glass 4. The principle of installing the steel bar 1 as shown FIG. 5 is the same as described above.

The connecting element 141 of the fixing base 14 is used to fasten a link rod (not shown in the figure) of the windshield wiper of the automobile, such that the scraping portion 22 of the wiper blade 2 corresponds to the windshield glass 4 of the automobile. Since both ends of the wiper blade 2 are pressed towards the windshield glass 4 by the curvely bent portions 11, and the scraping portion 22 of the wiper blade 2 can be attached closely onto the windshield glass 4 by the curvely bent portions 11 on both ends of the steel bar 1, so that a link rod of the windshield wiper drives the steel bar 1, so that the scraping portion 22 of the wiper blade 2 can scrape rain and dirt from the windshield glass 4 effectively. If both ends of the wiper blade 2 cannot be attached closely onto the windshield glass 4, a curvature of the steel bar 1 is increased to attach both ends of the wiper blade 2 closely with the windshield glass 4. Since the steel bar 1 reduces its cross-sectional area by both sides of the dent 12 at the middle, the elasticity is reduced, so that the link rod of the windshield wiper can apply a force normally to press the middle of the steel bar 1, and the middle of the wiper blade 2 can be attached closely with the windshield glass 4, and both ends of the middle of the wiper blade 2 can scrap rain and dirt from the windshield glass 4 effectively. In addition, the windshield wiper steel bar 1 of the invention can decrease the pressure of the steel bar 1 on the wiper blade 2 to reduce any abnormal swing produced by the wiper blade 2 corresponding to different curvatures during the scraping process or reduce any abnormal sound and vibrations caused by oil stains remained on the surface of the windshield glass 4. The principle of application and effect of the steel bar 1 as shown in FIG. 5 are the same as described above.

In summation of the description above, the improved windshield wiper steel bar structure of the invention can attach the wiper blade closely with the automobile windshield glass by the steel bar, after the wiper blade is installed to the steel bar, so as to achieve a more effective scraping effect, and the present invention complies with the patent application requirements, and thus is duly filed for patent application.

What is claimed is:

1. An improved windshield wiper steel bar structure, comprising a curvely bent portion disposed separately on both ends of the steel bar, at least one dent disposed at the middle of the steel bar, wherein the windshield wiper steel bar structure is in a single piece configuration and wherein the curvely bent portion bents no more than 45° toward a wiper blade.

2. An improved windshield wiper steel bar structure, comprising a curvely bent portion disposed separately on both ends of the steel bar, at least one penetrating hole disposed at the middle of the steel bar, wherein the windshield wiper steel bar structure is in a single piece configuration, wherein the curvely bent portion bents no more than 45° toward a wiper blade, and wherein the penetrating hole occupies only a portion of a longitudinal length of the windshield wiper steel bar structure.

3. The improved windshield wiper steel bar structure of claim 1, wherein the steel bar has the dent disposed separately on both sides of the center of the steel bar.

4. The improved windshield wiper steel bar structure of claim 3, wherein the two dents separately have a slot.

5. The improved windshield wiper steel bar structure of claim 2, wherein the penetrating hole has at least one slot.
